(19) United States
(12) Patent Application Publication
(10) Pub. No.: US 2008/0296330 A1
(43) Pub. Date: Dec. 4, 2008

(54) MOUNTABLE STORAGE ARRANGEMENT

(75) Inventors: D. Scott KALOUS, Kenosha, WI (US); Raymond H. KLEIN, II, Bellingham, WA (US); Scott STEVENS, Cudahy, WI (US)

Correspondence Address: CALFEE, HALTER & GRISWOLD LLP, 1400 KEYBANK CENTER, 800 SUPERIOR AVENUE, CLEVELAND, OH, 44114, US

(73) Assignee: MASTER LOCK COMPANY, LLC, Oak Creek, WI (US)

(21) Appl. No.: 12/130,151

(22) Filed: May 30, 2008

Related U.S. Application Data
(60) Provisional application No. 60/941,448, filed on Jun. 1, 2007.

(51) Int. Cl. B60R 9/06

(52) U.S. Cl. 224/519; 224/484; 224/495; 224/546; 224/564

(57) ABSTRACT

A mountable storage arrangement includes a mounting frame and a mountable storage device. The mounting frame includes a draw tube and a base member and upright member secured to the draw tube. The base member includes a support member having an axially extending portion and a laterally extending portion. The mountable storage device includes a base portion having a lower frame engaging surface including a recess sized to receive the support member to limit lateral and axial movement of the base portion with respect to the base member. The mountable storage device further includes an upright portion having an attachment feature configured to be secured to a corresponding attachment feature of the upright member to limit vertical movement of the base portion with respect to the base member when the support portion of the base member is received in the base portion recess.

### CROSS REFERENCE TO RELATED APPLICATION

This application claims the benefit of U.S. Provisional Patent Application Ser. No. 60/941,448, entitled MOUNTABLE STORAGE ARRANGEMENT and filed Jun. 1, 2007, the entire disclosure of which is incorporated herein by reference, to the extent that it is not conflicting with the present application.

### BACKGROUND

Storage arrangements or devices, such as, for example, racks or cargo carriers, may provide secure storage for many different types of items, including, for example, luggage, bicycles, skis, and other cargo. Many racks and carriers are configured to mount to a vehicle, such as, for example, a car, light truck, or sport utility vehicle. In some circumstances, an item stored on a rack may be heavy, large, or otherwise awkward to lift or lower, which may make it difficult to lift the item onto the rack or to retrieve the item from the rack, particularly where the rack is configured to store items relatively high off the ground.

### SUMMARY

The present application describes mountable storage arrangements for securing an item or items to a vehicle. In one embodiment, a mounting frame is secured to a receiver tube of a vehicle, the mounting frame being configured to securely receive an item retaining member or storage device, such as, for example, a cargo bag, case, or platform. According to an inventive aspect of the present application, the storage device may be provided with a base portion having a lower recess configured to receive a corresponding support member of the mounting frame, to limit axial and lateral movement of the base portion with respect to the mounting frame. An upper portion of the storage device may be attachable to the mounting frame, for example, to prevent vertical movement of the storage device with respect to the mounting frame, and resulting disengagement of the support member from the base portion recess.

Accordingly, in one embodiment, a mountable storage arrangement includes a mounting frame and a mountable storage device. The mounting frame includes a draw tube and a base member and upright member secured to the draw tube. The base member includes a support member having an axially extending portion and a laterally extending portion. The mountable storage device includes a base portion having a lower frame engaging surface including a recess sized to receive the support member to limit lateral and axial movement of the base portion with respect to the base member. The mountable storage device further includes an upright portion having an attachment feature configured to be secured to a corresponding attachment feature of the upright member to limit vertical movement of the base portion with respect to the base member when the support portion of the base member is received in the base portion recess.

### BRIEF DESCRIPTION OF THE DRAWINGS

Features and advantages of the invention will become apparent from the following detailed description made with reference to the accompanying drawings, wherein:

FIG. 1 is a perspective view of a mounting frame;

FIG. 2A is a lower perspective view of a storage device;

FIG. 2B is an upper perspective view of the storage device of FIG. 2A;

FIG. 2C is a perspective view of the storage device of FIG. 2A in a folded condition;

FIG. 2D is a perspective view of a storage device including a cargo bag enclosure;

FIG. 3 is a lower perspective view of the storage device of FIG. 2A secured to the mounting frame of FIG. 1;

FIG. 4 is a perspective view of a mounting frame configured to receive two storage devices;

FIG. 5 is an upper rear perspective view of the mounting frame of FIG. 4 retaining two storage devices; and

FIG. 6 is a perspective view of a mounting frame configured to be secured in multiple pivotal positions.

### DETAILED DESCRIPTION OF THE INVENTION

This Detailed Description of the Invention merely describes embodiments of the invention and is not intended to limit the scope of the specification or claims in any way. Indeed, the invention as recited in the claims is broader than and unlimited by the embodiments discussed herein, and the terms used have their full ordinary meaning.

The present application contemplates a mountable storage arrangement, for example, for mounting to a receiver of a vehicle. The mountable storage arrangement may be configured to accommodate one or more retaining members or mountable storage devices for retaining and securing one or more items to the arrangement. Many different types of storage devices may be utilized, including, for example, frames or racks (such as bicycle racks or ski racks), platforms (to support, for example, luggage or a lawnmower), or containers (including rigid or flexible containers, such as cargo carriers). Various mounting assemblies and storage devices are shown and described in co-pending U.S. patent application Ser. No. 11/701,726 (Pub. No. 2008-0001052), entitled USER ADJUSTABLE STORAGE ARRANGEMENT and filed Feb. 2, 2007 (the “'726 application”), the entire disclosure of which is hereby incorporated by reference, to the extent that it is not conflicting with the present application.

According to an inventive aspect of the present application, to accommodate attachment to different types of storage devices and/or to facilitate loading or unloading of items on the storage device, a mounting frame may be configured to stabilize and/or secure a base portion of a storage device. By providing the mounting arrangement with a supporting member that stabilizes or secures the base portion of the storage device, a user may attach the storage device to the mounting arrangement (or detach the storage device from the mounting arrangement) using less lifting or lowering effort, particularly where the storage device and/or or its contents are heavy. In one embodiment, the mounting frame includes a base member, which may, but need not, be substantially horizontal. The storage device includes a base portion having a bottom surface that includes a recess that is complementary shaped with a support member of the frame's base member, such that the base portion of the storage device may be stabilized and substantially supported by the mounting frame when the support member is received in the base portion recess. Further, a close fit engagement of the support member with the complementary shaped recess may serve to prevent or limit lateral and axial movement of the base portion with respect to the support member, without resort to mechanical attachment of the base portion to the support member.

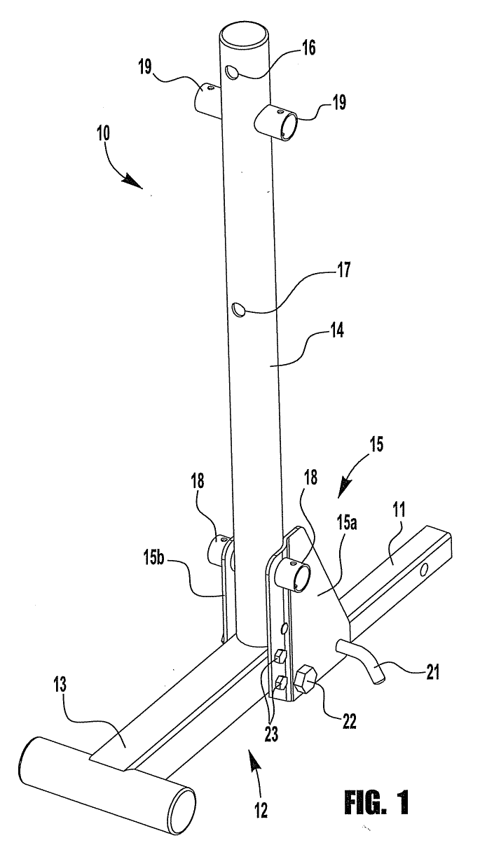

FIG. 1 illustrate an exemplary embodiment of a mounting frame 10 assembly with a trailer hitch receiver tube of a vehicle, such as a pickup truck or SUV. The exemplary frame includes a draw tube 11 for assembly with a vehicle receiver tube, a base member 12 for supporting and retaining a storage device, and an upright member 14 for attaching to the storage device. Many different configurations for joining the draw tube 11, base member 12, and upright member 14 may be utilized. In the illustrated embodiment, the draw tube 11, base member 12, and upright member 14 are joined by a bracket 15 including plates 15a, 15b secured to the base member 12 by fasteners 23, to the upright member 14 by cross port members 18, and to the draw tube 11 by a fastener 22 and a hitch pin 21. The draw tube 11 may be provided in various sizes to accommodate different sizes or classes of receiver tubes. In one embodiment, the draw tube may be provided in a standard size (e.g., for use with a class II receiver tube) and may be fitted with an adapter for assembly with a receiver tube of a different size (e.g., a class III receiver tube).

While a straight tubular, axially extending support member and corresponding straight recess may provide sufficient stability and support during mounting, in other embodiments, the support member may be shaped to provide additional stability and support by including both an axially extending portion and a laterally extending portion. In one example, the base member and corresponding recess are T-shaped to provide additional stability and support. The exemplary base member 12 includes a T-shaped support member 13 sized to be received in a corresponding, complementary shaped recess in a base portion of a storage device.

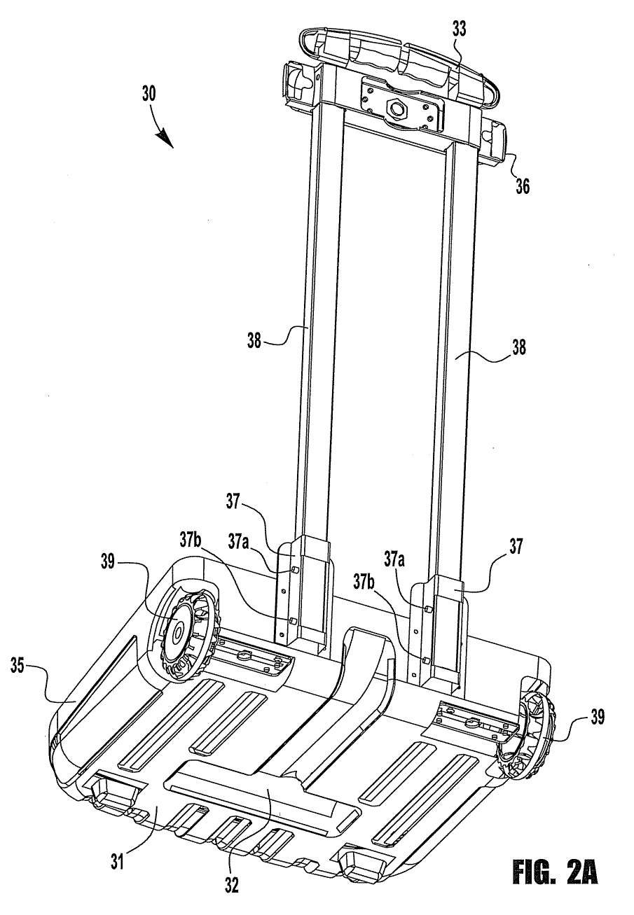

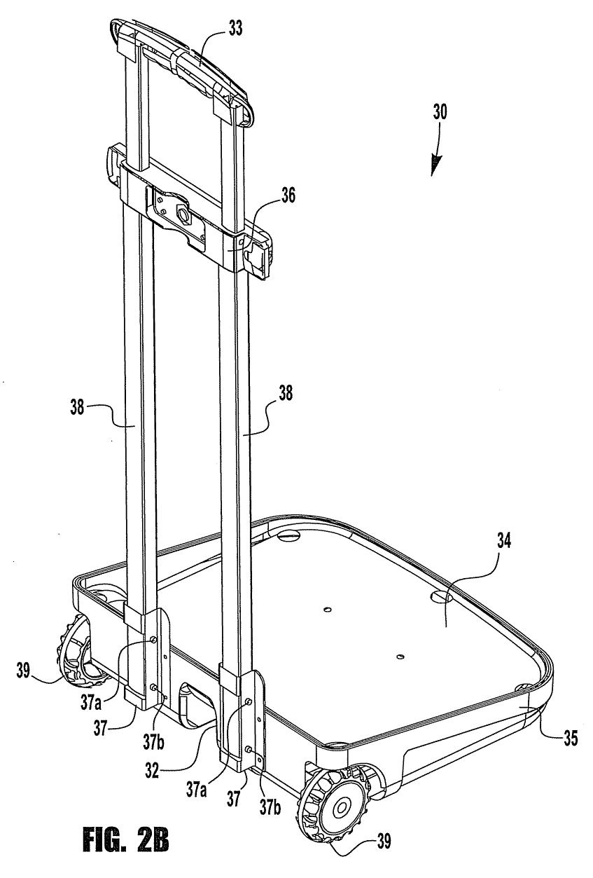

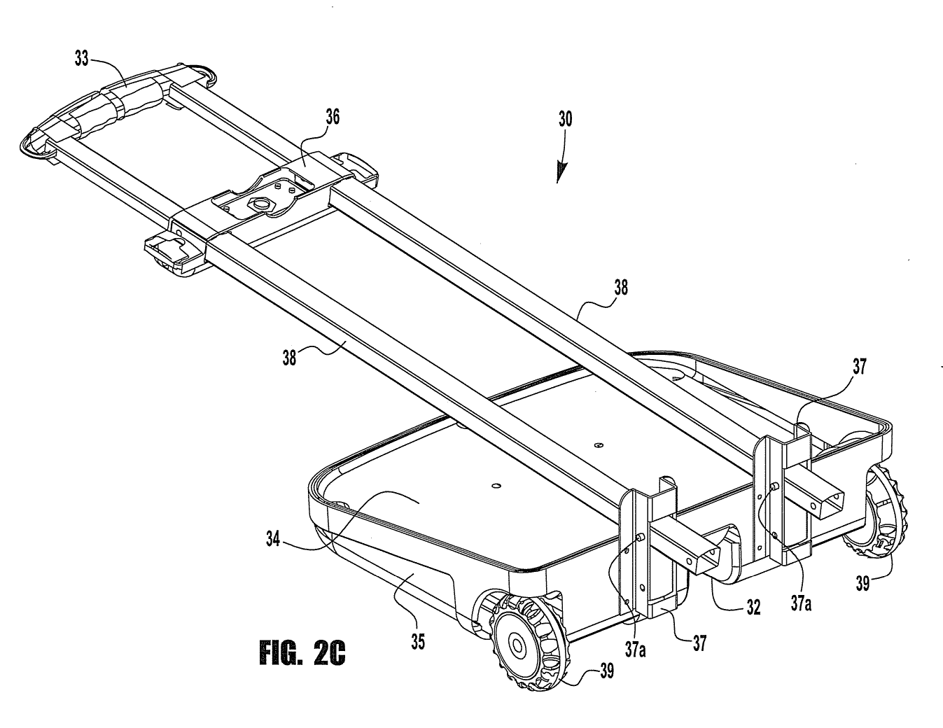

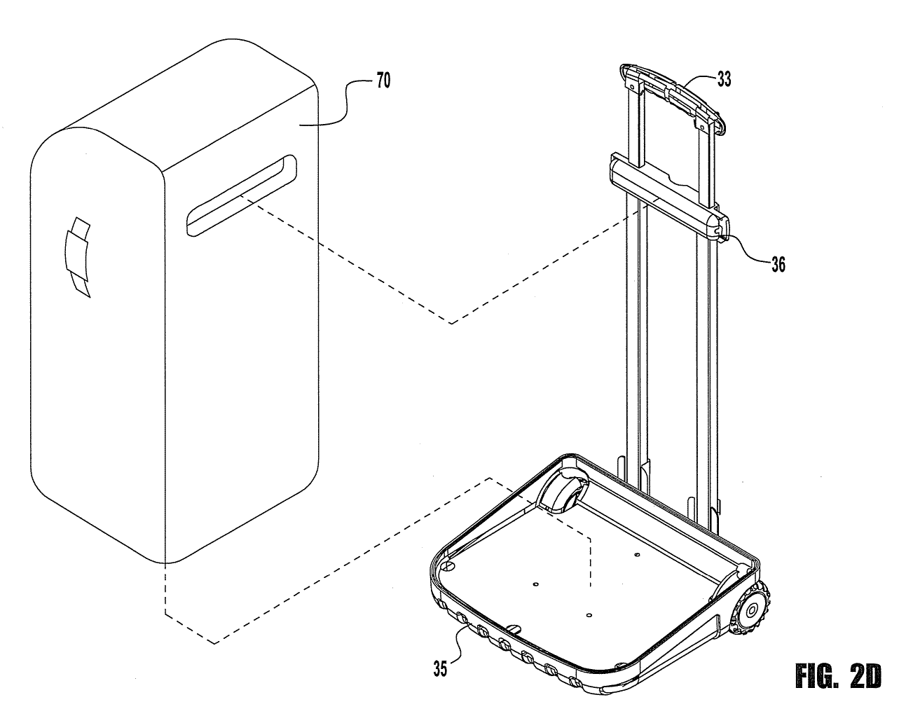

FIGS. 2A-2D illustrate an exemplary storage device 30 configured to function as a storage frame for retaining, for example, a cargo bag 70 (as shown in FIG. 2D). The storage device 30 includes a base portion 35 having an upper retaining surface 34 and a lower frame engaging surface 31. The lower surface includes a recess 32 sized to receive a support member of a mounting frame (e.g., the support member 13 of the mounting frame 10 of FIG. 1). The base portion 35 may be attached to vertical frame members 38 by bracket portions 37. As shown in FIG. 2C, the frame members 38 may be pivotable with respect to the bracket portion 37 by removing fasteners 37b (see FIGS. 2A and 2B) rigidly securing the frame members 38 in the vertical orientation, such that the storage device 30 may be folded by pivoting the frame members 38 about fasteners 37a (for example, for storage when not in use). The exemplary storage device 30 further includes wheels 39 to facilitate the transporting of stored items to the mounting frame 10. Additionally (not shown), one or more wheels or other such mechanisms may be provided at a front portion of the base portion 35, to allow the base portion 35 to be more easily tilted forward for aligning the recess 32 of the base portion with the base member 12. The exemplary storage device also includes an upper portion 36, which may be secured, for example, to a cargo bag 70 (see FIG. 2D), and a handle portion 33, which may be telescopically received in the frame members 38.

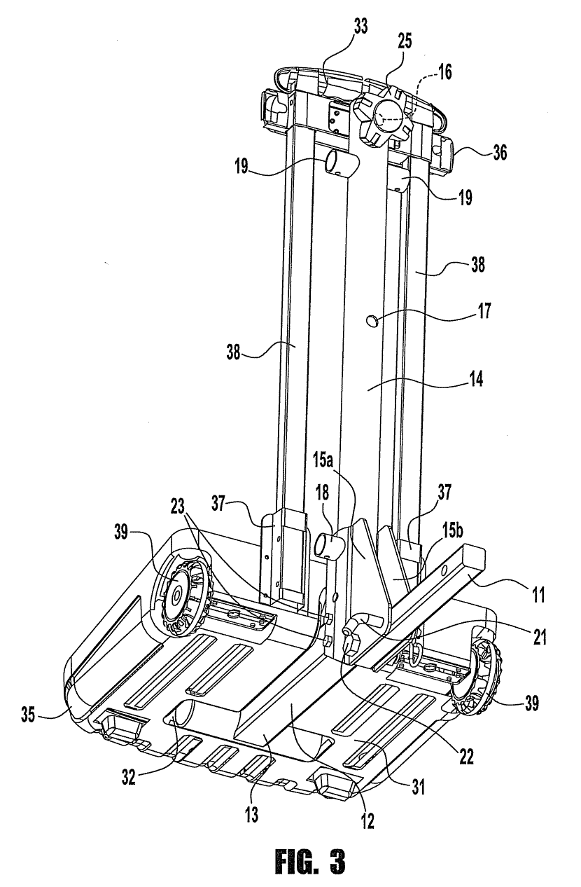

To fully secure the storage device 30 to the mounting frame 10, an additional attachment configuration, such as clasps, latches or fasteners, may be used. As engagement between the base portion 35 and the support member 13 provides support and stability for the storage device, less effort by the user is necessary as the storage device 30 is being attached to the mounting frame 10. While the storage device 30 may be attached or fastened to the frame 10 at any location, in one embodiment, as shown in FIG. 3, the storage device 30 includes an upper portion 36 having an attachment feature (e.g. a mounting hole, clasp, strap, or fastener) configured to attach to a corresponding attachment feature of the upright member 14. In addition to securing and stabilizing the upper portion 36 of the storage device 30, this attachment securely retains the support member 13 in the recess 32 to limit lateral and axial movement of the base portion 35 with respect to the base member 12.

Many different configurations may be used to attach the storage device 30 to the mounting frame 10, including, for example, threaded fasteners 25 inserted through one or more openings 16, 17 in the upright member 14 and secured to a threaded mounting hole 36a in the upper portion 36 of the storage device 30. In another embodiment (not shown), a threaded fastener with a pivotable locking clamp may be provided to lockingly secure the upper portion 36 of the storage device to the upright member 14. An example of such a locking clamp fastener is described in U.S. application Ser. No. 11/455,437 (Pub. No. 2007-0012834), entitled CLAMP and filed on Jun. 19, 2006, the entire disclosure of which is hereby incorporated by reference to the extent that it is not conflicting with the present application.

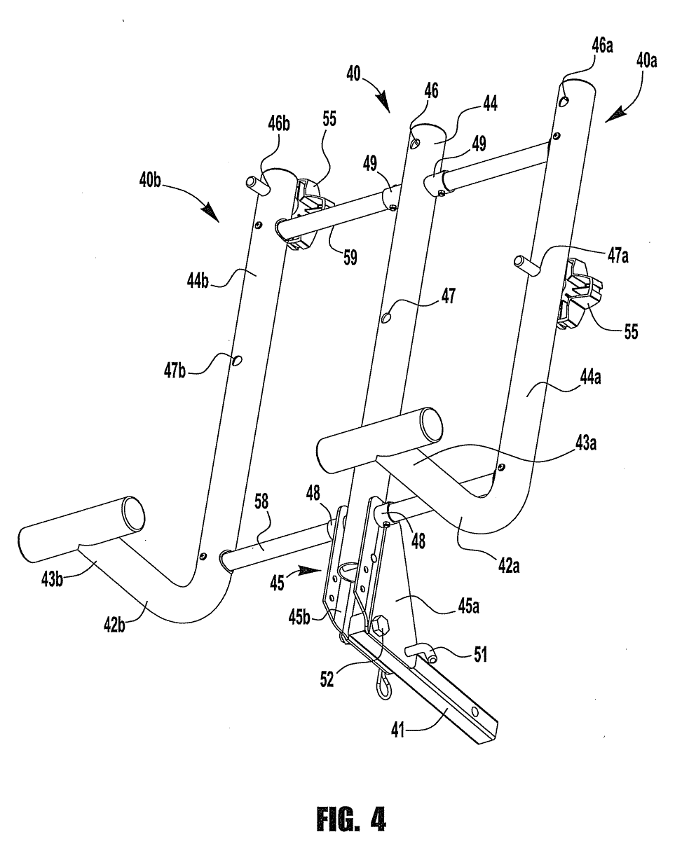

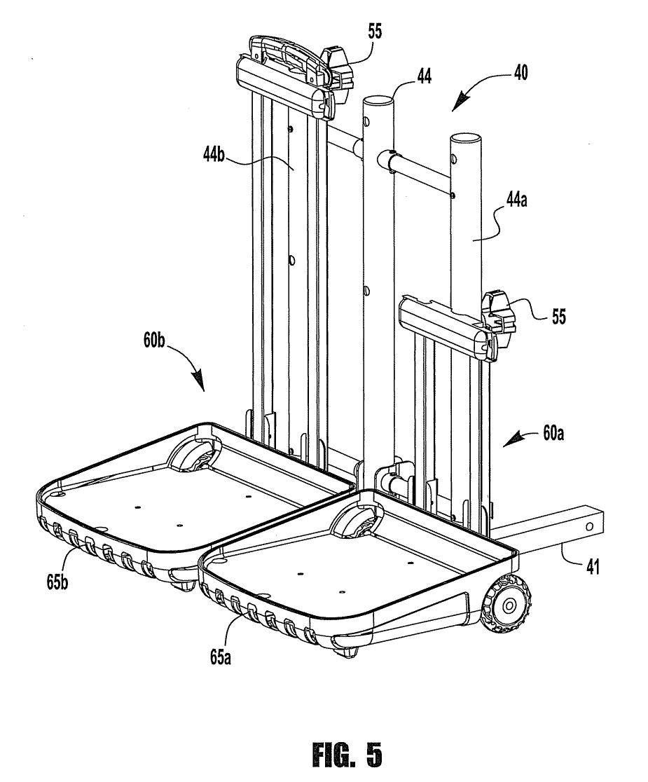

In other embodiments, a mounting arrangement may include a frame configured to support and attach with multiple storage devices. FIGS. 4 and 5 illustrate an exemplary mounting frame 40 having two side frame portions 40a, 40b including upright members 44a, 44b and corresponding base members 42a, 42b. The side frame portions 40a, 40b are attached to a central upright member 44 by one or more tubular cross members 58, 59, which extend through, and may be fastened to, corresponding cross port members 48, 49 of the central upright member. The central upright member 44 is connected to a draw tube 41 by a bracket 45 (formed by bracket plates 45a, 45b). The two side frame portions 40a, 40b are configured to support and secure two storage devices 60a, 60b, as shown, for example, in FIG. 5. As shown, the inclusion of attachment features (mounting holes 46a, 47a, 46b, 47b) at multiple locations on one or both of the side upright members 44a, 44b allows storage devices 50a, 50b of different sizes to be secured to the mounting frame 40. Additionally, a base member (for example, the base member 12 of FIG. 1), may be assembled to the draw tube 41 to provide a third location on the mounting frame 40 for supporting a storage device, with one or more attachment features 46, 47 on the central upright member 44 for attaching to the storage device.

To further facilitate loading a storage device onto a vehicle mounted frame, all or part of the frame may be configured to be pivotable with respect to a draw tube, allowing one or more support members to be lowered to facilitate engagement with corresponding recesses in one or more storage devices. In the embodiments of FIGS. 1 and 4, the brackets 15, 45 (and base members and upright members) may pivot about a fastener 22, 52 when the hitch pin 21, 51 is removed from aligned openings in the bracket 15, 45 and the draw tube 11, 41. This relationship allows the support members 13, 43a, 43b to be pivoted from a substantially horizontal storage position to a declined loading position. Other types of locking pins, fasteners, or other components may be inserted through the aligned bracket and draw tube openings to releasably secure a bracket or hinge portion in a desired pivotal position (e.g., the fully upright storage position). In another embodiment, a mounting frame may be provided with a user operated mechanism including one or more retractable locking pins extending from within the draw tube through openings in the bracket to rigidly hold the support member in a desired position, such as an upright storage position. When the pins are retracted from the corresponding openings (e.g., by pulling a lever, operating a locking mechanism, or some other user operation), the bracket becomes free to pivot with respect to the draw tube. An example of one such user operated rack pivoting mechanism is described in the '726 application.

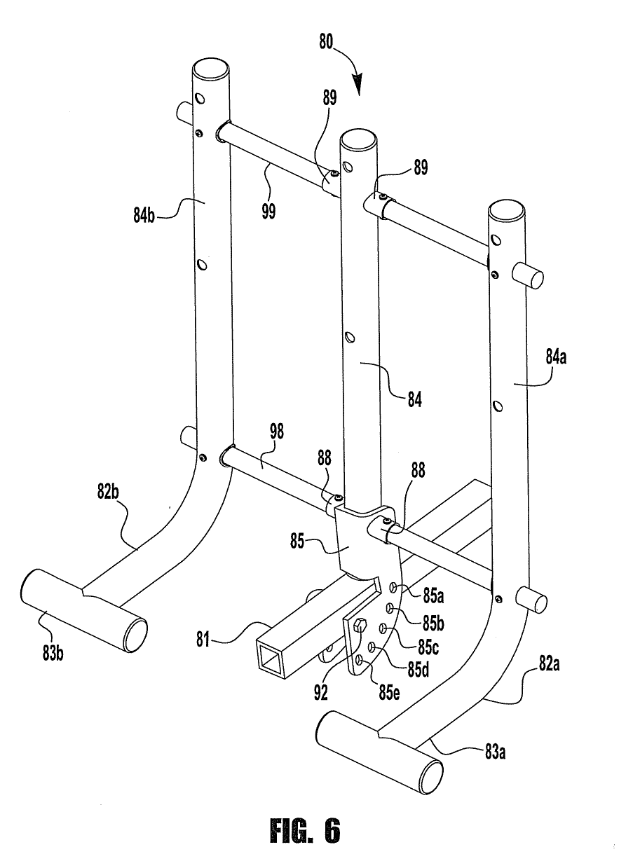

In another embodiment, a mounting frame may be configured to be secured in one or more declined loading positions. FIG. 6 illustrates one such exemplary mounting frame 80, in which a bracket 85 secured to the base members 83a, 83b and upright members 84a, 84b (through cross member 88) is pivotable with respect to the draw tube 81 about a pin, bolt or other such fastener 92 to lower the support members 83a, 83b, to facilitate engagement with a base portion of a storage device. As shown, the bracket 85 includes openings 85a, 85e positioned to align with corresponding openings (not shown) in the draw tube 81 in predetermined positions of the bracket 85 with respect to the draw tube 81 (for example, an upright storage position and a declined loading position). While the openings 85a, 85e may be limited to openings corresponding to a fully upright, storage position, and a fully declined loading position, additional openings 85b, 85c, 85d may be provided to correspond with one or more incremental positions between the storage position and the fully declined loading position. To secure the bracket in the desired predetermined pivotal position, a locking pin, fastener, or other such component may be inserted through the aligned openings 85a-85e of the bracket 85 and draw tube 81.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A mountable storage arrangement for mounting to a horizontal, axially extending receiver tube of a vehicle, the arrangement comprising:
a mounting frame comprising:
a draw tube including a first end portion configured to be secured to the receiver tube;
a base member secured to the draw tube, the base member including a support member having an axially extending portion and a laterally extending portion; and
an upright member secured to the draw tube and extending upward from the draw tube when the draw tube is secured to the receiver; and
a mountable storage device comprising:
a base portion including an upper retaining surface for supporting one or more items to be stored, and a lower frame engaging surface including a recess for receiving the support member; and
an upright portion extending substantially perpendicular to the base portion, the upright portion including an attachment feature configured to be secured to the upright member.

2. The mountable storage arrangement of claim 1, wherein the mounting frame further comprises a hinge portion securing the base member to the draw tube, the hinge portion being operable to pivot the base member between a substantially horizontal storage position and a declined loading position.

3. The mountable storage arrangement of claim 2, wherein the hinge portion secures the upright member to the draw tube and is further operable to pivot the upright member between a substantially vertical storage position and a declined loading position.

4. The mountable storage arrangement of claim 1, wherein the support member comprises a T-shaped portion.

5. The mountable storage arrangement of claim 1, wherein the attachment feature of the upright portion comprises mounting holes.

6. The mountable storage arrangement of claim 1, wherein the base member is laterally spaced from the draw tube.

7. The mountable storage arrangement of claim 1, further comprising a second base member secured to the draw tube and laterally spaced from the first stated base member, the second base member including a second support portion extending at least partially laterally with respect to the draw tube.

8. The mountable storage arrangement of claim 7, further comprising a second mountable storage device including a base portion having an a lower frame engaging surface including a recess sized to receive the second support portion to limit lateral and axial movement of the base portion with respect to the second base member.

9. The mountable storage arrangement of claim 7, wherein the support portion of the second base member is sized to be received in the base portion recess of the mountable storage device to limit lateral and axial movement of the base portion with respect to the second base member.

10. The mountable storage arrangement of claim 1, wherein the base member and the upright member are joined to form a rigid L-shaped member.

11. The mountable storage arrangement of claim 1, wherein the upright portion of the mountable storage device is pivotable with respect to the base portion between an upright position and a folded position.

12. The mountable storage arrangement of claim 1, wherein the recess of the lower frame engaging surface is sized to receive the support member to limit lateral and axial movement of the base portion with respect to the base member, and further wherein the attachment feature of the upright portion is configured to be secured to the upright member to limit vertical movement of the base portion with respect to the base member when the support portion of the base member is received in the base portion recess.

13. A mounting frame for mounting to a horizontal, axially extending receiver tube of a vehicle, the mounting frame comprising:
a draw tube including a first end portion configured to be secured to the receiver tube;
first and second base members each laterally spaced from the draw tube and secured to the draw tube by a cross member connected to a hinge portion operable to pivot the first and second base members between a substantially horizontal storage position and a declined loading position, the first and second base members including corresponding first and second support members for supporting a container thereon, each of the first and second base members including an axially extending portion and a laterally extending portion; and
first and second upright members extending perpendicular to the corresponding first and second base members, each of the first and second upright members including an attachment feature for securing a container thereto.

14. The mounting frame of claim 13, wherein the hinge portion is configured to secure the first and second base members in either one of the storage position and the loading position.

15. The mounting frame of claim 13, wherein the hinge portion is configured to secure the first and second base members in at least one position between the storage position and the loading position.

16. The mounting frame of claim 13, wherein the first and second support members each comprise T-shaped portions.

17. The mounting frame of claim 13, further comprising a center upright member extending from the hinge portion and receiving the cross member therethrough.

18. A method for securing a cargo item to a vehicle having a horizontal, axially extending receiver tube, the method comprising:
securing a draw tube of a mounting frame to the receiver tube, the mounting frame further including a substantially horizontal base member and a substantially vertical upright member each secured to the draw tube, the base member including a support member having an axially extending portion and a laterally extending portion;
securing the cargo item onto a base portion of a mountable storage device;
placing the base portion of the mountable storage device onto the support member, such that the support member is received in a recess in a lower surface of the base portion to limit lateral and axial movement of the base portion with respect to the base member; and
securing an attachment feature of an upright portion of the mountable storage device to a corresponding attachment feature of the upright member, thereby limiting vertical movement of the base portion with respect to the base member to prevent disengagement of the support member from the recess.

19. The method of claim 18, wherein securing the attachment feature of the upright portion of the mountable storage device to the corresponding attachment feature of the upright member comprises locking the upright portion to the upright member.

20. The method of claim 18, further comprising pivoting the base member from a substantially horizontal storage position to a declined loading position prior to placing the base portion of the mountable storage device onto the support member.

21. The method of claim 18, further comprising pivoting the base member from a declined loading position to a substantially horizontal storage position after placing the base portion of the mountable storage device onto the support member.
